(19) United States
(12) Patent Application Publication
(10) Pub. No.: US 2023/0394424 A1
(43) Pub. Date: Dec. 7, 2023

(54) ORDER PICK-UP CAPACITY MODELING AND PREDICTION

(71) Applicant: Target Brands, Inc., Minneapolis, MN (US)

(72) Inventors: SANIA IRSHAD, Minneapolis, MN (US); PATRICK CRANE, Minneapolis, MN (US)

(21) Appl. No.: 17/832,322

(22) Filed: Jun. 3, 2022

(51) Int. Cl. G06Q 10/08; G06Q 30/06

(52) U.S. Cl. CPC G06Q 10/0836; G06Q 30/0605

(57) ABSTRACT

The present application describes a modeling process, model, and applications thereof which may provide a method for organizing and interpreting data related to online pick-up orders to predict future demand growth. The model may allow an enterprise such as a retail enterprise or a grocery enterprise to more efficiently anticipate increases in demand for online pick-up ordering; predict the overall staging area storage for each store; and more efficiently allocate retail space, refrigeration/freezer equipment, parking spots, staff, and other related resources to meet online pick-up ordering demand. In some examples, the disclosed model provides a method for predicting future pick-up demand and associated resource needs based on inputs such as historical financial data and unique store data. The outputs may be used by enterprise personnel to determine which and how many resources, such as refrigerator equipment, will be required to meet demand in a specified future time period.

### BACKGROUND

An enterprise with one or more brick-and-mortar stores may offer its products to customers by in-store shopping, ship-to-home ordering from a website, pick-up of an online order at the store, or a combination of these methods. When orders for pick-up of an online order are fulfilled, the requested items may be gathered in a “staging area” prior to pick-up. In order to keep the items at the appropriate temperature, the staging area may include a dry storage area, a refrigerator area, and a freezer area. The size of the staging area may vary widely between store locations based on pick-up demand. Additionally, the amount and ratio of different resources necessary within the staging area, such as the ratio of storage for dry goods to coolers for refrigerated goods and freezers for frozen goods, may vary widely between store locations. Demand for pick-up orders may also vary widely by store location and may also vary over time for a single location.

### SUMMARY

An enterprise with one or more brick-and-mortar stores may offer its products to customers via pick-up of an online order at the store. The size of the staging area for items to fulfill pick-up orders may vary widely between store locations based on pick-up demand. Additionally, the amount and ratio of different resources necessary within the staging area, such as the ratio of storage for dry goods to coolers for refrigerated goods and freezers for frozen goods, may vary widely between store locations. Demand for pick-up orders may also vary widely by store location and may also vary over time for a single location. As demand in pick-up volume or ratio of category of item changes for a store location, the staging area must change proportionately to accommodate more items or a different ratio of different types of items. In general, the disclosed modeling process, model, and applications thereof provide a method for organizing and interpreting data related to online pick-up orders to predict future demand growth. The model may allow an enterprise such as a retail enterprise or a grocery enterprise to more efficiently anticipate increases in demand for online pick-up ordering; predict the overall staging area storage for each store; and more efficiently allocate retail space, refrigeration/freezer equipment, parking spots, staff, and other related resources to meet online pick-up ordering demand.

Accordingly, the present application describes a computing system, including at least one processor and at least one memory storing computer-executable instructions for predicting an amount of resources required to accommodate a pick-up demand projection at each store of a plurality of stores for a retail enterprise. In some examples, the computer-executable instructions, when executed by the at least one processor, may cause the computer to receive a plurality of data inputs (which may include: historical pick-up sales data associated with the plurality of stores; resource capacity data associated with a resource for each store of the plurality of stores; and store attribute data of each store of the plurality of stores). In some examples, the instructions may further cause the computer to group the plurality of stores into a plurality of clusters, based on the store attribute data, which may include a plurality of attributes selected from among: dry vs. low-temperature product data; division breakout percentage; pick-up acceleration rate; pick-up saturation data; census data of an area surrounding each of the plurality of stores, the census data including guest demographics; store velocity grouping; units per order; and proximity of one or more competing stores. The instructions may cause the computer to determine a demand growth curve to fit demand data associated with each of the plurality of clusters by fitting one or more polynomial equations onto the demand data associated with each of the plurality of clusters; calculate the rate of change for each of the plurality of clusters based on the demand growth curve associated with each of the plurality of clusters; and based on the rate of change, categorize each of the plurality of clusters into one of a plurality of demand band. In some examples, the instructions may further cause the computer to determine the pick-up demand projection for each store of each cluster of each of the plurality of demand bands over a specified time period, where the pick-up demand projection may include low-temperature product demand (for example, refrigerated and/or frozen product demand) and dry product demand. The instructions may cause the computer to: predict an amount of each of the plurality of resources necessary to accommodate the pick-up demand for each store (where the plurality of resources may include low-temperature product capacity and dry product capacity); generate a resource allocation plan for each cluster, for at least one resource of the plurality of resources; assign the resource allocation plan to each store of each cluster.

In some examples, a method for predicting an amount of resources required to accommodate a pick-up demand projection at a store of a retail enterprise may include receiving a plurality of data inputs (which may include: historical pick-up sales data associated with the plurality of stores; resource capacity data associated with a resource for each store of the plurality of stores; and store attribute data of each store of the plurality of stores). The plurality of stores may be grouped into a plurality of clusters, based on the store attribute data, which may include a plurality of attributes selected from among: dry vs. low-temperature product data; division breakout percentage; pick-up acceleration rate; pick-up saturation data; census data of an area surrounding each of the plurality of stores, the census data including guest demographics; store velocity grouping; units per order; and proximity of one or more competing stores. A demand growth curve may be determined which fits demand data associated with each of the plurality of clusters by fitting one or more polynomial equations onto the demand data associated with each of the plurality of clusters; calculate the rate of change for each of the plurality of clusters based on the demand growth curve associated with each of the plurality of clusters; and based on the rate of change, categorize each of the plurality of clusters into one of a plurality of demand band. In some examples, a pick-up demand projection may be determined for each store of each cluster of each of the plurality of demand bands over a specified time period, where the pick-up demand projection may include low-temperature product demand (for example, refrigerated and/or frozen product demand) and dry product demand. An amount of each of the plurality of resources necessary to accommodate the pick-up demand for each store (where the plurality of resources may include low-temperature product capacity and dry product capacity) may be predicted. A resource allocation plan for each cluster may be generated for at least one resource of the plurality of resources. The resource allocation plan may be assigned to each store of each cluster.

In some examples, a system may include a resource planning platform which may include a first computer system configured to calculate the rate of change for each of the plurality of clusters based on the demand growth curve associated with each of the plurality of clusters and categorize each of the plurality of clusters into one of a plurality of demand bands based on the rate of change. The first computer system may also be configured to determine the pick-up demand projection (which may include freezer produce demand, refrigerated product demand, and/or dry product demand) for each store of each cluster of each of the plurality of demand bands over a specified time period and predict an amount of each of the plurality of resources (which may include freezer product capacity, refrigerated product capacity, and/or dry product capacity) necessary to accommodate the pick-up demand for each store. The first computer system may generate a resource allocation plan for each cluster, for at least one resource of the plurality of resources and assign the resource allocation plan to each store of each cluster. In some examples, a planogram layout platform, executing on a second computer system communicatively connected to the first computer system, may be configured to receive the resource allocation plan for at least one store of the plurality of stores; receive planogram input data (which may include a current planogram for the at least one store and store attribute data associated with the at least one store, which may include store footprint capacities associated with the one or more resources); generate a new planogram for the at least one store, based on the resource allocation plan and the store attribute data; and generate a user interface including the new planogram.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an example system for predicting future pick-up demand and associated resource needs for an enterprise, according to an example.

FIG. 2 illustrates an example method for predicting an amount of resources required to accommodate a pick-up demand projection at each store of a plurality of stores for a retail enterprise, according to an example.

FIG. 3 illustrates an example method for predicting an amount of resources required to accommodate a pick-up demand projection at a store of a retail enterprise, according to an example.

FIG. 4 illustrates an example display depicting results from grouping a plurality of stores into clusters, according to an example.

FIG. 5 illustrates an example display depicting trend lines for categories of pick-up demand, according to an example.

FIG. 6 illustrates an example display depicting trend lines comparing pick-up demand and same-day crowdsourced customer delivery service demand, according to an example.

FIG. 7 illustrates an example display depicting demand for pick-up and same-day crowdsourced customer delivery services, according to an example.

FIG. 8 illustrates an example display depicting a table comprising projected pick-up and resource demand by cluster, according to an example.

FIG. 9 illustrates an example display depicting a current store layout including staging area and associated resources and a recommended future store layout including updated staging area and associated updated resources, according to an example.

FIG. 10 illustrates an example block diagram of a computing system.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

An enterprise with one or more brick-and-mortar stores may offer its products to customers via pick-up of an online order at the store. The size of the staging area for items to fulfill pick-up orders may vary widely between store locations based on pick-up demand. Additionally, the amount and ratio of different resources necessary within the staging area, such as the ratio of storage for dry goods to coolers for refrigerated goods and freezers for frozen goods, may vary widely between store locations. Demand for pick-up orders may also vary widely by store location and may also vary over time for a single location. As demand in pick-up volume or ratio of category of item changes for a store location, the staging area should be adjusted proportionately to accommodate more items or a different ratio of different types of items.

In general, the disclosed modeling process, model, and applications thereof provide a method for organizing and interpreting data related to online pick-up orders to predict future demand growth. The model may allow an enterprise, such as a retail enterprise or a grocery enterprise, to anticipate changes in demand for online pick-up ordering more efficiently; predict the overall staging area storage for each store more accurately; and more efficiently allocate retail space, refrigeration/freezer equipment, parking spots, staff, and other related resources to meet online pick-up ordering demand.

In some examples, the disclosed model provides a method for predicting future pick-up demand and associated resource needs based on inputs such as historical financial data, unique store demographic data, and external benchmarks. In some examples, the model may produce graphical outputs that group stores into “demand bands.” The outputs may be used by enterprise personnel to determine which and how many resources, such as refrigerator and freezer equipment, will be required to meet demand in a specified future time period. In some examples, the model may output or enable the determination of a time at which demanded pick-up staging capacity will exceed the store's current pick-up staging capabilities.

In some examples, the model may group a plurality of stores (in some examples, hundreds or thousands of stores) into clusters of stores (in some examples, between 10 and 50 clusters). In some examples, the stores are grouped into clusters using a principal component analysis (PCA). In some examples, the PCA considers store attributes including pickup demand, income demographics, and the ratio of temperature-controlled goods to non-temperature-controlled goods within pickup orders, among other factors. In some examples, store attributes may include dry goods vs. temperature-controlled (refrigerated, frozen, ambient) vs. general merchandise; division breakout percentage; units per order; store format or brand information; store area census data and/or demographics; adoption of and/or saturation of grocery pickup; acceleration of pickup; and/or competitor enterprise proximity or capability. In some examples, a demand growth curve is determined for each cluster by fitting polynomial equations up to the fifth polynomial onto the cluster's demand data and determining which curve has the highest R\hat{ }2 value. In some examples, the third- or fourth-degree polynomial equation has the highest R\hat{ }2 value. Once the best-fitting equation is identified, the rate of change for the cluster may be derived from the equation. In some examples, based on the cluster's rate of change, the cluster may be placed into a demand band that classifies the cluster (and the stores grouped within the cluster) as high growth, average growth, or low growth. Using the demand band classification, demand projections may be made for each store for a specified future time period.

In some examples, outputted demand projections may include peak demand, off-peak demand, freezer good demand, refrigerated good demand, and dry good demand.

In some examples, input data to the model may include outlier stores whose historical data was skewed, for example by natural disasters, political situations, or strict local rules or quarantines which closed stores or required a particular method of shopping. In some examples, these outlier stores may be identified in the data if the projected pickup order sales exceeds a specified percentage of the store's total sales. Once the store has been identified as an outlier, the underlying data may be corrected and/or the additional demand may be redistributed to other stores in a similar location, if appropriate.

In some examples, the model is re-run to improve its accuracy and/or update its results. In some examples, the model is rerun twice a year. In some examples, the model is run off of input data for a time period which is shorter than the specified time period for which the model makes its predictions. For example, the model may be run twice a year, based on the previous six months of sales data, to generate a demand projection for a future time period of five years. In some examples, the actual demand during the time period the data was collected (for example, the period of six months) may be compared to the projected demand so that the model can more reliably determine when demand for pick-up orders is saturated.

In some examples, the demand projections can be outputted to enterprise personnel such as operations managers so that they may determine intra-store changes that need to be made in the next specified time period to meet the projected demand. For example, the model may predict that the store will run out of refrigerator space in the staging area in two years, and the enterprise personnel may order more refrigerator equipment or consult with others to initiate a remodel process. In some examples, the demand projections may be used to determine needs for additional staff (in some examples, based on a “picking efficiency”), or needs for additional pick-up parking spots.

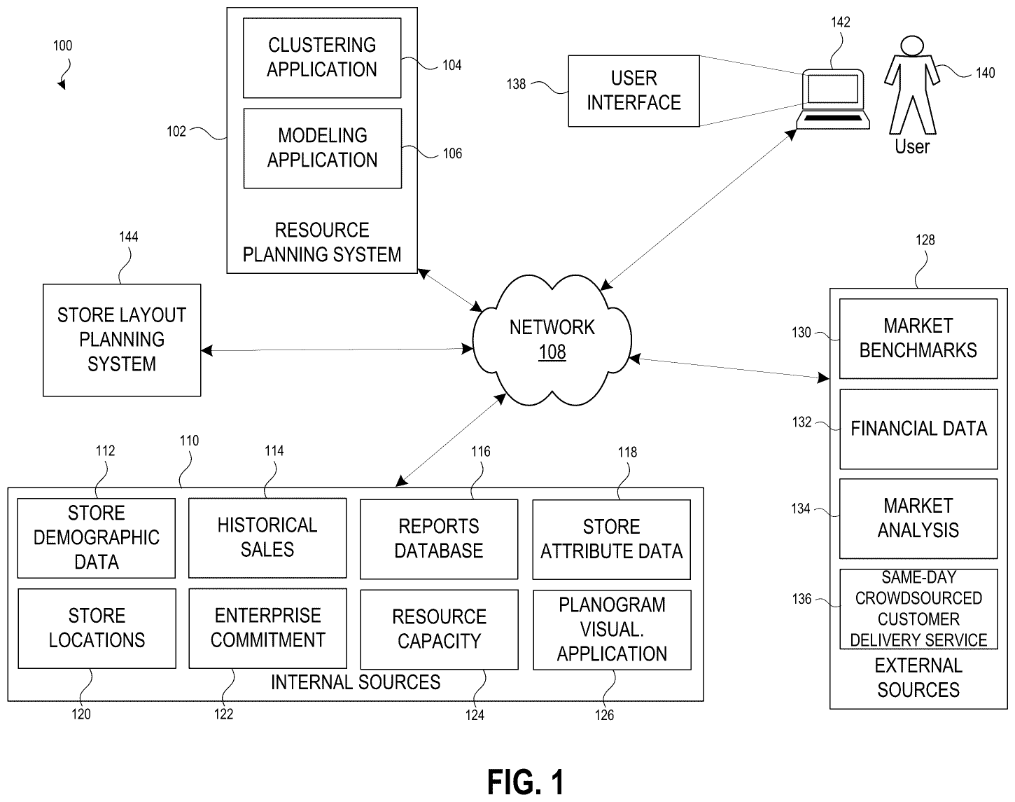

These and other examples will be explained in more detail below with respect to FIG. 1-FIG. 10.

FIG. 1 illustrates an example system 100 for predicting future pick-up demand and associated resource needs for an enterprise, according to an example. As will be described in more detail below, the system 100 may include a resource planning system 102, a clustering application 104, a modeling application 106, a network 108, internal sources 110, store demographic data 112, historical sales 114, reports database 116, store attribute data 118, store locations 120, enterprise commitment 122, resource capacity 142, planogram visualization (visual.) application 126, external sources 128, market benchmarks 130, financial data 132, market analysis 134, same-day crowdsourced customer delivery service 136, user interface 138, user 140, device 142, and store layout planning system 144.

In an example, resource planning system 102 (including clustering application 104 and/or modeling application 106) may receive input data from internal sources 114 and/or external sources 128. Resource planning system 102 may include sub-processors, tools, and services, to aid in the intake, processing, analysis, and display of the data and inputs, as will be discussed herein. The various input data may be communicated to clustering application 104 via network 108.

In some examples, as described herein, network 108 may include a computer network, an enterprise intranet, the Internet, a LAN, a Wide Area Network (WAN), wireless transmission mediums, wired transmission mediums, other networks, and combinations thereof. Although network 108 is shown as a single network in FIG. 1, this is shown as an example and the various communications described herein may occur over the same network or a number of different networks.

In some examples, the input data may include some or all of: store demographic data 112 (for example, the population near a store, the average income of residences near a store, the population density near a store, the average age of the population near a store, etc.); historical sales 114 (for example, total or a category of pick-up sales for one or more stores over a time period); reports database 116 (for example, past data reports and outputs from clustering application 104 and/or modeling application 106); store attribute data 118 (for example, store attributes may include dry goods vs. temperature-controlled (refrigerated, frozen, ambient) vs. general merchandise; division breakout percentage; units per order; store format or brand information; store area census data and/or demographics; adoption of and/or saturation of grocery pickup; acceleration of pickup; and/or competitor enterprise proximity or capability); store locations 120; enterprise commitment 122 (for example, enterprise resource commitment guidance including budgets, capital allowances, etc.); resource capacity 142 (for example, the amount of floor space of a store; the amount of floor space currently used for pick-up at a store; the amount of dry, frozen, and/or refrigerated space available at a store; the amount of dry, frozen, and/or refrigerated space currently utilized for pick-up at a store; the number of refrigeration/freezer units or dry storage units at a store; the footprint and cubic feet of the refrigeration/freezer units or dry storage units, etc.); planogram visualization application 126 (for example, an application which may store existing planograms associated displays); market benchmarks 130; financial data 132; market analysis 134 (for example, actual or predicted market trends); and/or same-day crowdsourced customer delivery service 136 (for example, a third-party delivery service which picks up orders from the enterprise and delivers them to customers). In some examples, user 140 may provide input data to resource planning system 102 (including clustering application 104 and/or modeling application 106).

In some examples, the input data may be from internal sources 110; in some examples, the input data may be from external sources 128. Input data sources may be stored in one or more various databases, which may be virtual (e.g. cloud-based); in other examples, they may network or drive-based.

In some examples, upon receiving the input data, clustering application 104 may group a plurality of stores associated with the enterprise, which may be a retail enterprise, into clusters, based at least off store attribute data 118, according to methods described herein. It may produce tables, graphs, or other appropriate display means of the clustered stores, which it may communicate via network 108 to a device 142 so that the display means may be displayed to a user 140 via a user interface 138. In some examples, clustering application 104 may store outputs (for example, data associated with clustering of stores) and/or other data into reports database 116.

In some examples, as described herein, the device 142 may be a desktop computer, a laptop computer, a tablet, a cell phone, a smart TV, a smart wearable device, or other appropriate electronic device which is capable of displaying the user interface 138. In an example, user 140 is an employee, operator, manager, or other agent of the enterprise. In an example, user interface 138 is a web application. In other examples, user interface 138 is a device application. In some examples, user interface 138 allows user 140 to interact with the displayed tables, graphs, or other appropriate display means to better view the data based on user 140's needs and preferences (for example, filtering, sorting, customizing views and charts, or toggling different options on and off).

In some examples, modeling application 106 may receive the input data as described herein and clustering data (for example, from clustering application 104 and/or reports database 116). Upon receiving the data, modeling application 106 may: determine a demand growth curve to fit demand data associated with the clusters, calculate the rate of change for each of the plurality of clusters based on the demand growth curve, categorize each of the plurality of clusters into one of a plurality of demand bands, determine the pick-up demand projection (which may include freezer product demand, refrigerated product demand, and dry product demand) for each store of each cluster over a specified time period, predict an amount of resources (for examples, freezer product capacity, refrigerated product capacity, and dry product capacity) necessary to accommodate the pick-up demand for each store, generate a resource allocation plan for each cluster, and assign the resource allocation plan to each store of each cluster, according to methods described herein. It may produce tables, graphs, or other appropriate display means of the generated intermediate or final outputs, which it may communicate via network 108 to a device 142 so that the display means may be displayed to a user 140 via a user interface 138. In some examples, modeling application 106 may store outputs (for example, demand growth curves, rates of change, demand bands, pick-up demand projections, projected resource needs, and/or resource allocation plans) and/or other data into reports database 116.

In some examples, store layout planning system 144 may receive data from resource planning system 102 (for example, modeling application 116) and/or internal sources 110 (for example, reports database 116 and/or planogram visualization application 126). In some examples, store layout planning system 144 may store existing planograms and may update, edit, or create new planograms (store layout plans) based on the received data. In some examples, store layout planning system 144 may generate a display to be displayed as part of a user interface 138 on device 142 to user 140. In some examples, this display may include existing (parent) planograms, updated (child) planograms, both, and/or comparisons of parent and child planograms. By providing data from the modeling application 116 to the store layout planning system 144, a store layout planning process may be improved. Specifically, an amount of a store allocated to staging of pickup orders may be more accurately determined at the outset for different stores, and a cluster of like stores may be laid out in a common format or layout to avoid a requirement of individual, store-by-store layout processes.

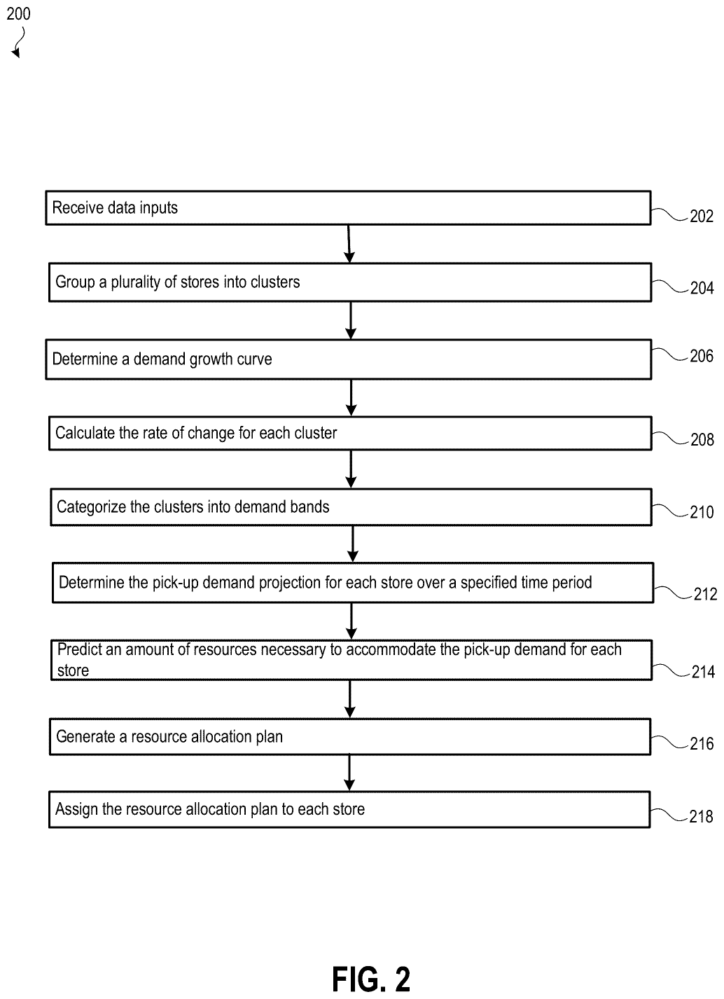

FIG. 2 illustrates an example method for predicting an amount of resources required to accommodate a pick-up demand projection at each store of a plurality of stores for a retail enterprise, according to an example. The method 200 may be performed by one or more systems of the system 100 shown and described with respect to FIG. 1.

Method 200 begins at step 202 with a resource planning system receiving data inputs. In some examples, the data inputs may include some or all of include historical pick-up sales data associated with the plurality of stores, resource capacity data associated with a resource for each store of the plurality of stores, store attribute data of each store of the plurality of stores, enterprise resource commitment guidance, demographic data associated with each store of the plurality of stores, same-day crowdsourced customer delivery service data, external market data, and/or other appropriate data inputs. In some examples, data inputs may be received from sources internal to the enterprise, external to the enterprise, or both.

In some examples, at step 204 the plurality of stores may be grouped into clusters based on the store attribute data. In some examples, the store attribute data may include attributes including: goods vs. temperature-controlled (refrigerated, frozen, ambient) vs. general merchandise; guest (customer) segments; guest (customer) demographics (for example, age, income level, etc.); pick-up maturity (adoption); pick-up saturation data; pick-up acceleration; census data of an area surrounding each of the plurality of stores; store velocity grouping; store capacities and formats; proximity/capacity of one or more competing stores; division breakout percentage; units per order; or other appropriate store attribute data. In an example, the stores may be grouped into clusters by applying principal component analysis to the store attributes. In some examples, applying principal component analysis may include generating features from the attributes via linear combinations of the attributes, selecting the most beneficial features, and grouping the stores into clusters based on the selected features.

In some examples, at step 206, a demand growth curve may be determined for each cluster, where the demand growth curve fits demand data associated with the cluster. In some examples, the demand growth curve may be determined by fitting one or more polynomial equations onto the demand data associated with each of the plurality of clusters. In some examples, fitting one or more polynomial equations onto the demand growth curve may include selecting a polynomial equations which has a highest r-squared value to be the demand growth curve for that cluster, where each of the polynomial equation may be a first, second, third, fourth, or fifth-order polynomial equation.

In some examples, at step 208, a rate of change may be calculated for each cluster, based on the demand growth curve associated with each cluster.

In some examples, at step 210, the each of the clusters may be categorized into demand bands, based on the rate of change. In some examples, the demand bands may be categorized into at least a low demand band, an average demand band, and a high demand band. These demand bands may be defined relative to each other (e.g., by segmenting the clusters such that generally equal numbers of stores fall within each band). In alternative implementations, discrete thresholds may be used to define separations among the demand bands. Such discrete thresholds may be definable by a user to subdivide clusters into groupings that are sufficiently close in terms of types and quantity of pick-up demand that they may be treated similarly for purposes of store layout planning. For example, dry goods, refrigerated goods, and freezer goods storage demand may be within a predetermined range or percentage, e.g., +/−10-25% of each other, or some other threshold.

In some examples, at step 212, the pick-up demand projection for each store (of each cluster of each demand band) over a specified time period may be determined. In some examples, the pick-up demand projection may include freezer product demand (for example, demand for frozen food products), refrigerated product demand (for example, demand for refrigerated food products), and/or dry product demand (for example, demand for ambient food products or non-food products). In some examples, the specified time period may be five years. In some examples, the specified time period is longer than a base time period to which the data inputs correspond. For example, the specified time period may be five years, and the data inputs may correspond to a time period of six months.

In some examples, the pick-up demand projection may include both peak and off-peak demand. In some examples, the pick-up demand projection may include peak demand of the freezer product demand, off-peak demand of the freezer product demand, peak demand of the refrigerated product demand, off-peak demand of the refrigerated product demand, peak demand of the dry product demand and/or off-peak demand of the dry product demand.

In some examples, the resource planning system may identify outlier stores, where a projected pick-up order sales exceeds a specified percentage of historical total sales of the outlier store, where the projected pick-up order sales is based on the pick-up demand projection. In some examples the specified percentage may be 25%, 30%, 33.3%, 35%, 40%, or 50% of the historical total sales, or any other appropriate percentage. In some examples, the outlier store may be excluded from the data; in some examples, the outlier store data may be adjusted to within normal levels to account for a situation that caused the store to become an outlier (for example, a government mandate that all orders must be delivery of pick-up).

In some examples, at step 214, an amount of resources necessary to accommodate the pick-up demand for each store may be predicted. In some examples, the resources may include freezer product capacity, refrigerated produce capacity, and/or dry product capacity. In some examples, resources may include parking spaces, store floor space, store volume, pick-up support staff, or other appropriate resources.

In some examples, at step 216, a resource allocation plan many be generated for each store or each cluster (applicable to each store within the cluster). In some examples, the resource allocation plan may include a one resource; in some examples the resource allocation plan may include multiple resources.

In some examples, at step 218, the resource allocation plan may be assigned to each store. In some examples, a resource allocation plan for a particular cluster may be assigned to each store within that cluster. In some examples, a user interface including the resource allocation plan may be generated and may be provided to a user as described herein. In some examples, the user interface may include the pick-up demand projection and a same-day crowdsourced customer delivery service projection.

In some examples, a future time at which the amount of one or more resources necessary to accommodate the pick-up demand for one of the stores will exceed the store capacity may be determined, based at least on the pick-up demand projection and store attribute data (which may include the current store capacity) associated with the store. In some examples, a user interface including the future time may be generated.

In some examples, outputs (for example, demand growth curves, rates of change, demand bands, pick-up demand projections, projected resource needs, future times, generated displays, and/or resource allocation plans) and/or other data may be stored into a reports database which may be accessible by other internal enterprise sources, the resource planning system, a store layout planning system/planogram layout platform, or other entity.

In some examples, the computing system(s) on which method 200 is executed may be communicatively connected to a second computer system, which may include a planogram layout platform (e.g. a store layout planning system) and which may be configured to receive the resource allocation plan. In some examples, the planogram layout platform may receive planogram input data, which may include a current planogram for at least one store and store attribute data associated with at least one store, and the store attribute data may include store footprint capacities associated with the one or more resources. The planogram layout platform may generate a new planogram for the store(s), based on the resource allocation plan and the store attribute data. In some examples, the planogram layout platform may generate a user interface comprising the new planogram, which may then be adjustable by a user for the store or stores to which that planogram may apply (e.g., one or more stores within a cluster or band, as described above).

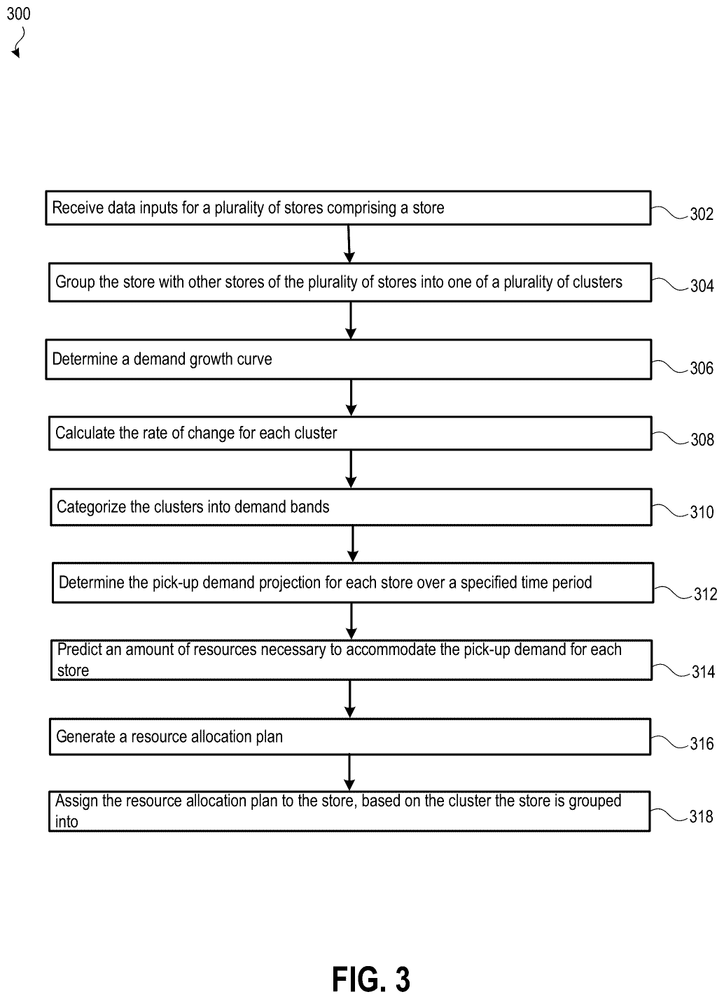

FIG. 3 illustrates an example method for predicting an amount of resources required to accommodate a pick-up demand projection at a store of a retail enterprise, according to an example. The method 300 may be performed by one or more systems of the system 100 shown and described with respect to FIG. 1. Method 300 details an example method for predicting resources required for a particular store, when a particular store is known from the outset of the method steps.

Method 300 begins at step 302 with a resource planning system receiving data inputs. In some examples, the data inputs may include some or all of include historical pick-up sales data associated with a plurality of stores which include the store, resource capacity data associated with a resource for each store of the plurality of stores including the store, store attribute data of each store of the plurality of stores including the store, enterprise resource commitment guidance, demographic data associated with each store of the plurality of stores including the store, same-day crowdsourced customer delivery service data, external market data, and/or other appropriate data inputs. In some examples, data inputs may be received from sources internal to the enterprise, external to the enterprise, or both.

In some examples, at step 304 the store may be grouped with other stores of the plurality of stores into clusters based on the store attribute data. In some examples, the store attribute data may include attributes including: goods vs. temperature-controlled (refrigerated, frozen, ambient) vs. general merchandise; guest (customer) segments; guest (customer) demographics (for example, age, income level, etc.); pick-up maturity (adoption); pick-up saturation data; pick-up acceleration; census data of an area surrounding each of the plurality of stores; store velocity grouping; store capacities and formats; proximity/capacity of one or more competing stores; division breakout percentage; units per order; or other appropriate store attribute data. In an example, the stores may be grouped into clusters by applying principal component analysis to the store attributes. In some examples, applying principal component analysis may include generating features from the attributes via linear combinations of the attributes, selecting the most beneficial features, and grouping the stores into clusters based on the selected features.

In some examples, at step 306, a demand growth curve may be determined for each cluster, where the demand growth curve fits demand data associated with the cluster. In some examples, the demand growth curve may be determined by fitting one or more polynomial equations onto the demand data associated with each of the plurality of clusters. In some examples, fitting one or more polynomial equations onto the demand growth curve may include selecting a polynomial equations which has a highest r-squared value to be the demand growth curve for that cluster, where each of the polynomial equation may be a first, second, third, fourth, or fifth-order polynomial equation.

In some examples, at step 308, a rate of change may be calculated for each cluster, based on the demand growth curve associated with each cluster.

In some examples, at step 310, the each of the clusters may be categorized into demand bands, based on the rate of change. In some examples, the demand bands may be categorized into at least a low demand band, an average demand band, and a high demand band, as described above.

In some examples, at step 312, the pick-up demand projection for each store (of each cluster of each demand band), including the store, over a specified time period may be determined. In some examples, the pick-up demand projection may include freezer product demand (for example, demand for frozen food products), refrigerated product demand (for example, demand for refrigerated food products), and/or dry product demand (for example, demand for ambient food products or non-food products). In some examples, the specified time period may be five years. In some examples, the specified time period is longer than a base time period to which the data inputs correspond. For example, the specified time period may be five years, and the data inputs may correspond to a time period of six months.

In some examples, the pick-up demand projection may include both peak and off-peak demand. In some examples, the pick-up demand projection may include peak demand of the freezer product demand, off-peak demand of the freezer product demand, peak demand of the refrigerated product demand, off-peak demand of the refrigerated product demand, peak demand of the dry product demand and/or off-peak demand of the dry product demand.

In some examples, the resource planning system may identify that the store is an outlier store, where a projected pick-up order sales exceeds a specified percentage of historical total sales of the outlier store, where the projected pick-up order sales is based on the pick-up demand projection. In some examples the specified percentage may be 25%, 30%, 33.3%, 35%, 40%, or 50% of the historical total sales, or any other appropriate percentage. In some examples, the outlier store may be excluded from the data; in some examples, the outlier store data may be adjusted to within normal levels to account for a situation that caused the store to become an outlier (for example, a government mandate that all orders must be delivery of pick-up).

In some examples, at step 314, an amount of resources necessary to accommodate the pick-up demand for each store, including the store, may be predicted. In some examples, the resources may include freezer product capacity, refrigerated produce capacity, and/or dry product capacity. In some examples, resources may include parking spaces, store floor space, store volume, pick-up support staff, or other appropriate resources.

In some examples, at step 316, a resource allocation plan many be generated for each cluster. In some examples, the resource allocation plan may include a one resource; in some examples the resource allocation plan may include multiple resources.

In some examples, at step 318, the resource allocation plan may be assigned to the store, based on the cluster that the store is grouped into. In some examples, a user interface including the resource allocation plan for the store may be generated and may be provided to a user as described herein. In some examples, the user interface may include the pick-up demand projection and a same-day crowdsourced customer delivery service projection.

In some examples, a future time at which the amount of one or more resources necessary to accommodate the pick-up demand for the store will exceed the store capacity of the store may be determined, based at least on the pick-up demand projection and store attribute data (which may include the current store capacity) associated with the store. In some examples, a user interface including the future time may be generated.

In some examples, generated output reports (for example, demand growth curves, rates of change, demand bands, pick-up demand projections, projected resource needs, future times, generated displays, and/or resource allocation plans) and/or other data may be stored into an enterprise reports database which may be accessible by other internal enterprise sources, the resource planning system, a store layout planning system/planogram layout platform, or other entity.

In some examples, the computing system(s) on which method 300 is executed may be communicatively connected to a second computer system, which may include a planogram layout platform (e.g. a store layout planning system) and which may be configured to receive the resource allocation plan.

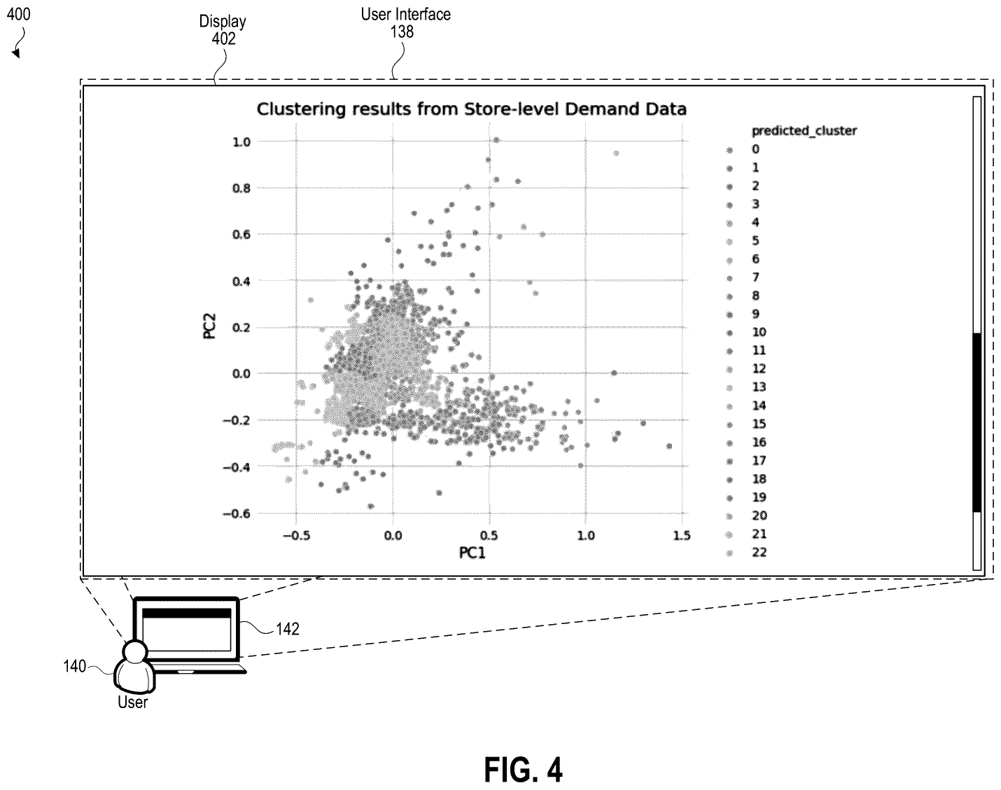

FIG. 4 illustrates an example display depicting results from grouping a plurality of stores into clusters, according to an example. User interface 138 may comprise display 402 and may be displayed via device 142 to user 140.

In some examples, display 402 includes a chart, depicting predicted clusters of stores, where the stores were grouped into those clusters based upon store attributes. In some examples, principal component analysis may be implemented, which may include generating features from the attributes via linear combinations of the attributes, selecting the most beneficial features, and grouping the stores into clusters based on the selected features. These clusters may be shown in a manner such as display 402.

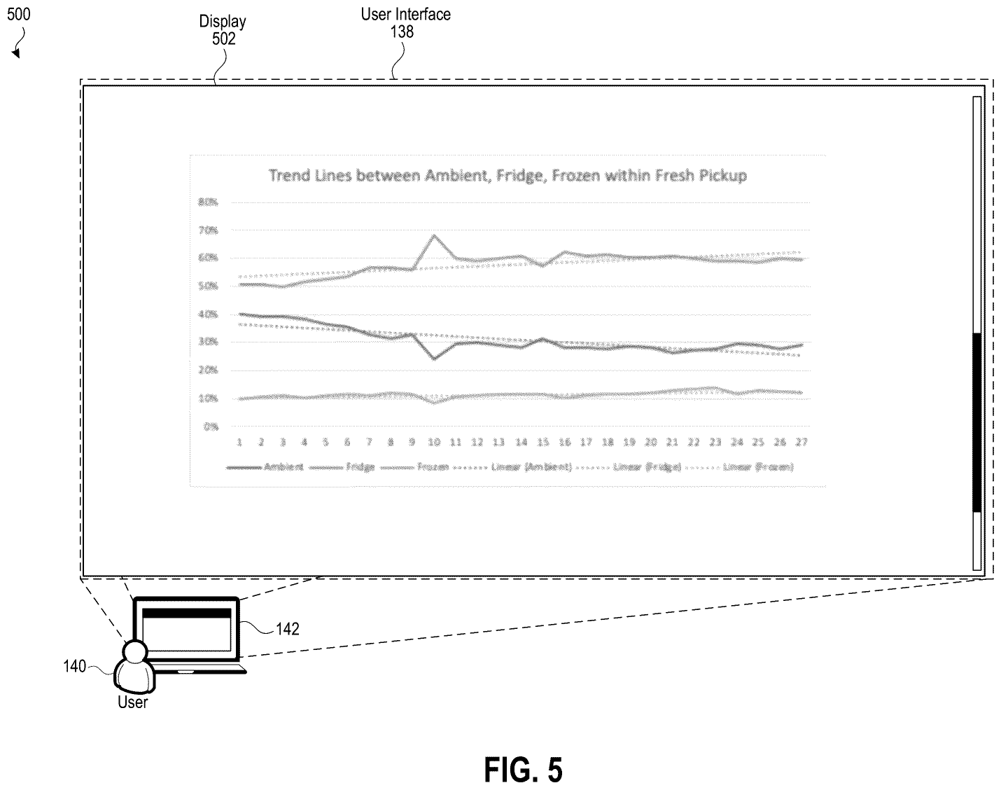

FIG. 5 illustrates an example display depicting trend lines for categories of pick-up demand, according to an example. User interface 138 may comprise display 502 and may be displayed via device 142 to user 140.

In some examples, display 502 may enable a user 140 to determine over a time period whether the demand for dry (ambient), refrigerated, and/or frozen pick-up is increasing or decreasing, and to what degree. Display 502 may also allow user 140 to compare the demand for different categories of pick-up. This may inform future decision-making by the enterprise, such as staffing, capital expenditure, store layout planning of existing or new buildings, or advertising. Display 502 may also include trend lines (for example, linear trend lines) which may allow for some prediction of pick-up demand into the future.

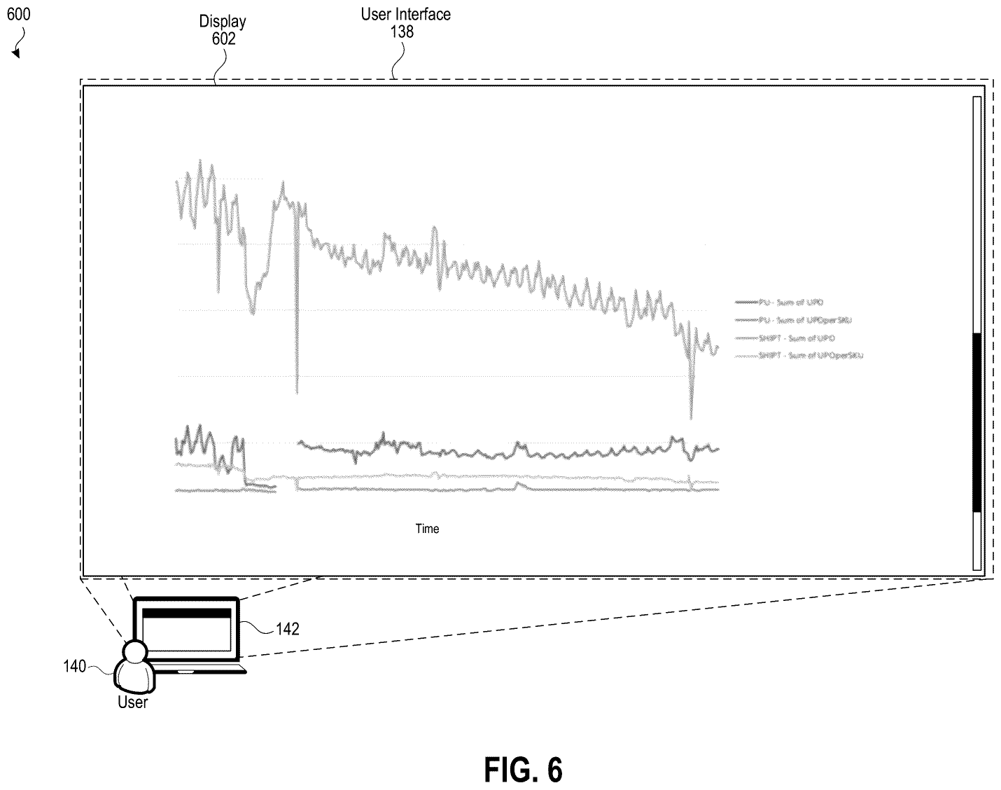

FIG. 6 illustrates an example display depicting trend lines comparing pick-up demand and same-day crowdsourced customer delivery service demand over time, according to an example. User interface 138 may comprise display 602 and may be displayed via device 142 to user 140.

In some examples, display 602 may enable user 140 to view enterprise pick-up data alongside same-day crowdsourced customer delivery services (for example, Shipt). This may allow user to accurately predict overall demand and coordinate resources to adequately satisfy the requirements of both pick-up and Shipt.

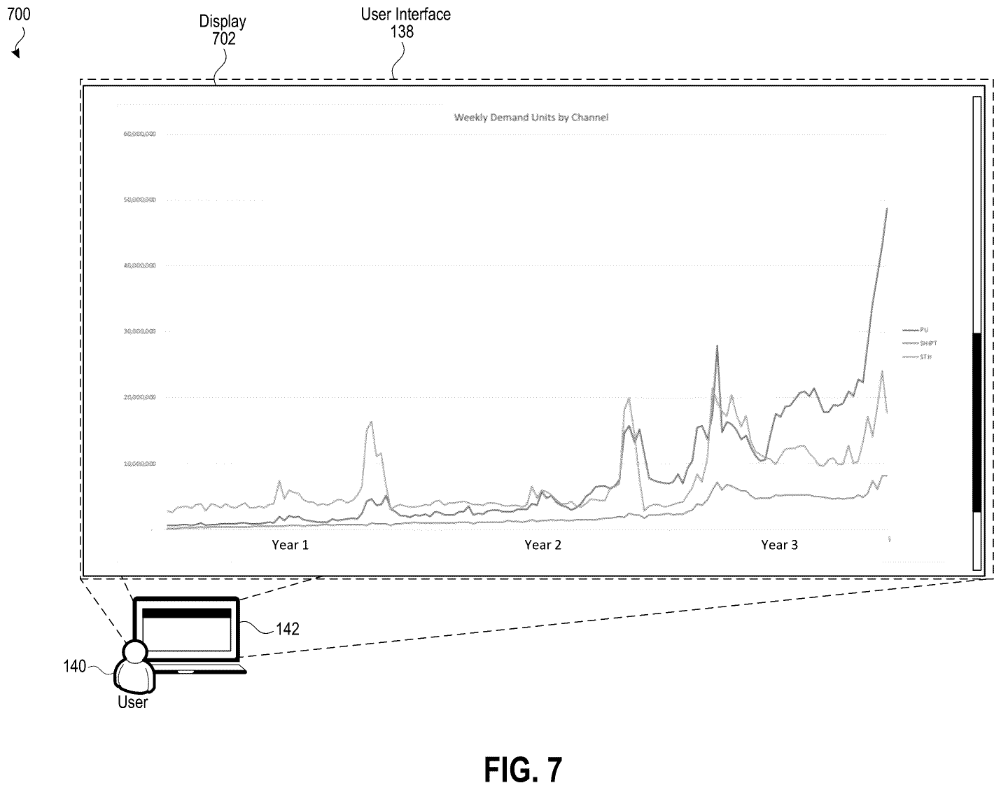

FIG. 7 illustrates an example display depicting demand for pick-up and same-day crowdsourced customer delivery services, according to an example. User interface 138 may comprise display 702 and may be displayed via device 142 to user 140.

In some examples, display 702 may enable user 140 to view enterprise pick-up data alongside same-day crowdsourced customer delivery services (for example, Shipt) and enterprise ship-to-home. This may allow user 140 to accurately predict overall demand and coordinate resources to adequately satisfy the requirements of each method of providing an item to a guest/customer, as well as informing future decision-making by the enterprise, such as staffing, capital expenditure, store layout planning of existing or new buildings, or advertising. In some examples, data in display 702 may be shown on a weekly basis and gathered over years.

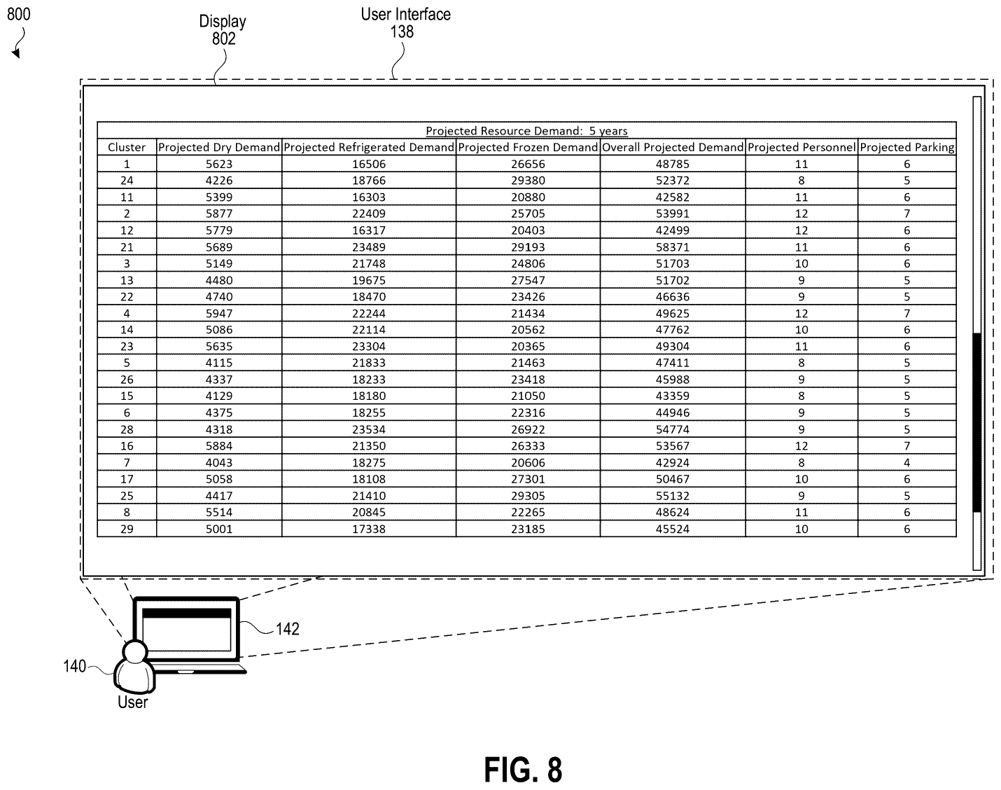

FIG. 8 illustrates an example display depicting a table comprising projected pick-up and resource demand by cluster. User interface 138 may comprise display 802 and may be displayed via device 142 to user 140.

In some examples, display 802 may include, by cluster, outputs from a resource planning system over a time frame or at a specified time after a time frame, such as: projected dry demand, projected refrigerated demand, projected frozen demand, overall projected demand, projected personnel/pick-up staffing, projected parking requirements, or other demand or resource outputs. Display 802 may enable user 140 to make future decisions for the enterprise, such as staffing, capital expenditure, store layout planning of existing or new buildings, or advertising. These decisions may be on a per-cluster basis, which may have the advantages of: applying to a group (cluster) of stores which have shared attributes and which will benefit from the decision; and applying to a cluster, thus creating an efficiency because a decision may not need to be made for each individual store in some examples.

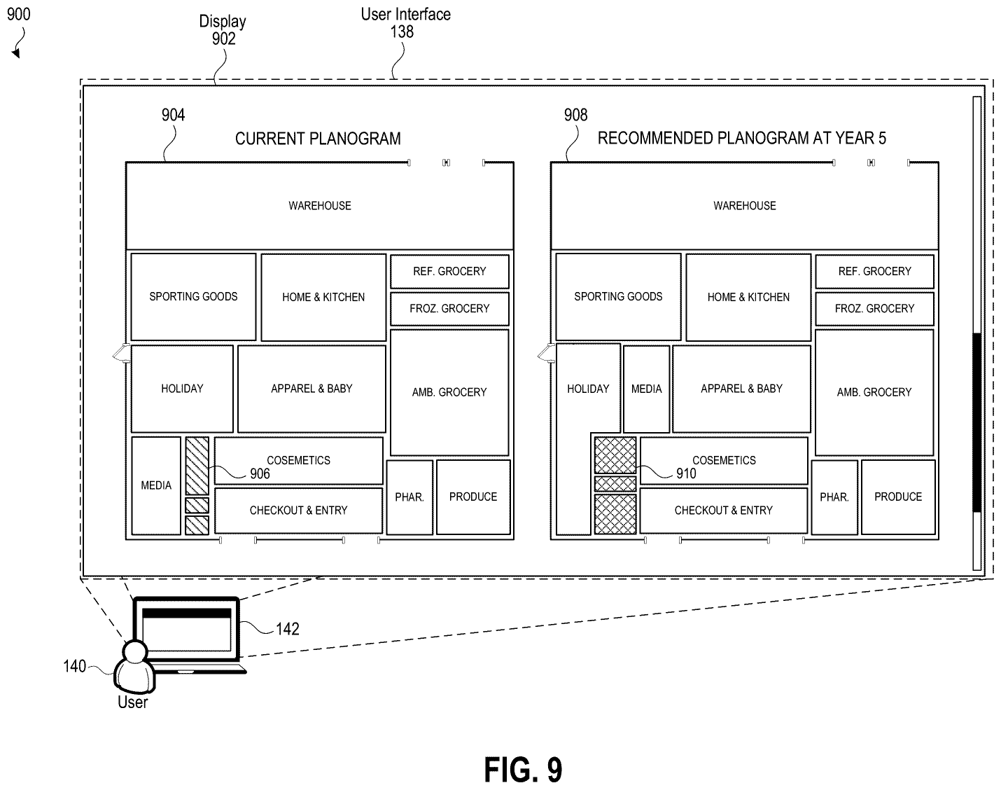

FIG. 9 illustrates an example display depicting a current store layout including staging area and associated resources and a recommended future store layout including updated staging area and associated updated resources. User interface 138 may comprise display 902 and may be displayed via device 142 to user 140.

For example, display 902 shows a current planogram 904 which includes a current pick-up staging area 906, which may include multiple resources such as space for refrigerated items, frozen items, and dry/ambient items. Each of these resources may take up a certain amount of floor space and volumetric space and may hold a particular amount of items (depending on the size, shape, and type of item). Display 902 may also include a recommended planogram 908, which may include a recommended pick-up staging area 910, which may be recommended for a cluster of stores or a particular store at a specified future time. Recommended pick-up staging area 910 may include updated resources, such as a number of refrigerators, freezers, or dry/ambient storage space. This may show on the planogram as a change in the designated volumetric or floor space of the store. In some examples, the amount of space needed for all resources or a particular resource may increase; in some examples, the amount of space needed for all resources or a particular resource may decrease. If the space required for the recommended pick-up staging area 910 in the store changes from the current pick-up staging area 906, the amount and/or location of space allocated to other items in the store (for example, electronic media, holiday items, apparel, etc.) may also be changed in recommended planogram 908 to accommodate for the changing resource requirements. In some examples, this may allow user 140 to visualize and plan for physical store layouts and make future capital expenditure decisions regarding resources with future budgets and schedules in mind.

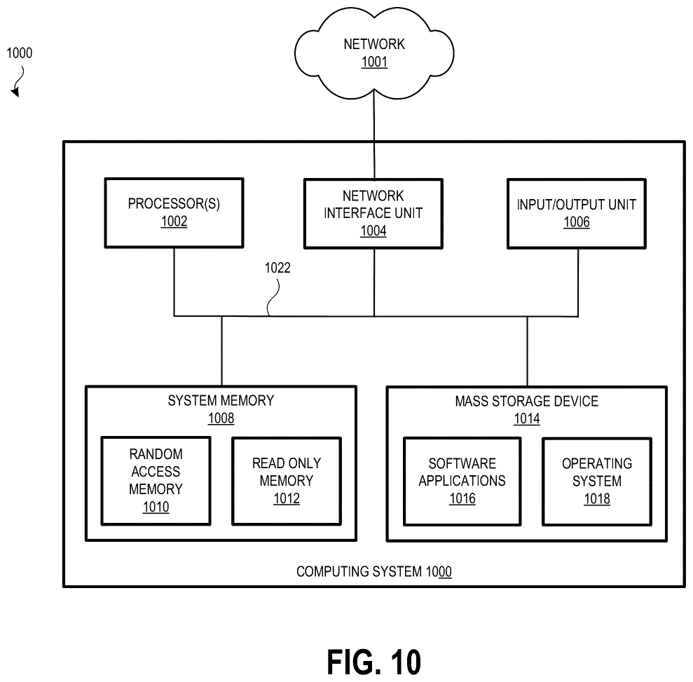

FIG. 10 illustrates an example block diagram of a virtual or physical computing system 1000. One or more aspects of the computing system 1000 can be used to implement the resource planning system 102, store instructions described herein, and preform operations described herein.

In the embodiment shown, the computing system 1000 includes one or more processors 1002, a system memory 1008, and a system bus 1022 that couples the system memory 1008 to the one or more processors 1002. The system memory 1008 includes RAM (Random Access Memory) 1010 and ROM (Read-Only Memory) 1012. A basic input/output system that contains the basic routines that help to transfer information between elements within the computing system 1000, such as during startup, is stored in the ROM 1012. The computing system 1000 further includes a mass storage device 1014. The mass storage device 1014 is able to store software instructions and data. The one or more processors 1002 can be one or more central processing units or other processors.

The mass storage device 1014 is connected to the one or more processors 1002 through a mass storage controller (not shown) connected to the system bus 1022. The mass storage device 1014 and its associated computer-readable data storage media provide non-volatile, non-transitory storage for the computing system 1000. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 1000.

According to various embodiments of the invention, the computing system 1000 may operate in a networked environment using logical connections to remote network devices through the network 1001. The network 1001 is a computer network, such as an enterprise intranet and/or the Internet. The network 1001 can include a LAN, a Wide Area Network (WAN), the Internet, wireless transmission mediums, wired transmission mediums, other networks, and combinations thereof. The computing system 1000 may connect to the network 1001 through a network interface unit 1004 connected to the system bus 1022. It should be appreciated that the network interface unit 1004 may also be utilized to connect to other types of networks and remote computing systems. The computing system 1000 also includes an input/output controller 1006 for receiving and processing input from a number of other devices, including a touch user interface display screen, or another type of input device. Similarly, the input/output controller 1006 may provide output to a touch user interface display screen or other type of output device.

As mentioned briefly above, the mass storage device 1014 and the RAM 1010 of the computing system 1000 can store software instructions and data. The software instructions include an operating system 1018 suitable for controlling the operation of the computing system 1000. The mass storage device 1014 and/or the RAM 1010 also store software instructions, that when executed by the one or more processors 1002, cause one or more of the systems, devices, or components described herein to provide functionality described herein. For example, the mass storage device 1014 and/or the RAM 1010 can store software instructions that, when executed by the one or more processors 1002, cause the computing system 1000 to receive and execute managing network access control and build system processes.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of modeling enterprise pick-up demand, technologies disclosed herein are applicable to data structures generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

What is claimed is:

1. A computing system, comprising:
at least one processor; and
at least one memory storing computer-executable instructions for predicting an amount of resources required to accommodate a pick-up demand projection at each store of a plurality of stores for a retail enterprise, the computer-executable instructions when executed by the at least one processor causing the computer to:
receive a plurality of data inputs, wherein the plurality of data inputs comprise:
historical pick-up sales data associated with the plurality of stores;
resource capacity data associated with a resource for each store of the plurality of stores; and
store attribute data of each store of the plurality of stores;
group the plurality of stores into a plurality of clusters, based on the store attribute data, the store attribute data comprising a plurality of attributes selected from among:
dry vs. low-temperature product data;
division breakout percentage;
pick-up acceleration rate;
pick-up saturation data;
census data of an area surrounding each of the plurality of stores, the census data including guest demographics;
store velocity grouping;
units per order; and
proximity of one or more competing stores;
determine a demand growth curve to fit demand data associated with each of the plurality of clusters by fitting one or more polynomial equations onto the demand data associated with each of the plurality of clusters;
calculate the rate of change for each of the plurality of clusters based on the demand growth curve associated with each of the plurality of clusters;
based on the rate of change, categorize each of the plurality of clusters into one of a plurality of demand bands;
determine the pick-up demand projection for each store of each cluster of each of the plurality of demand bands over a specified time period, wherein the pick-up demand projection comprises:
low-temperature product demand; and
dry product demand;
predict an amount of each of the plurality of resources necessary to accommodate the pick-up demand for each store, wherein the plurality of resources comprises:
low-temperature product capacity; and
dry product capacity;
generate a resource allocation plan for each cluster, for at least one resource of the plurality of resources; and
assign the resource allocation plan to each store of each cluster.

2. The computing system of claim 1, the computer-executable instructions further causing the computer to generate a user interface comprising the resource allocation plan.

3. The computing system of claim 1, the computer-executable instructions further causing the computer to generate a user interface comprising the pick-up demand projection and a same-day crowdsourced customer delivery service projection.

4. The computing system of claim 1, the computer-executable instructions further causing the computer to identify outlier stores of the plurality of stores, where a projected pick-up order sales exceeds a specified percentage of historical total sales of the outlier store, wherein the projected pick-up order sales is based on the pick-up demand projection.

5. The computing system of claim 1, the computer-executable instructions further causing the computer to:
determine, based at least on the pick-up demand projection and store attribute data associated with one of the plurality of stores, the store attribute data comprising a store capacity, a future time at which the plurality of resources necessary to accommodate the pick-up demand for the one of the plurality of stores will exceed the store capacity; and
generating a user interface comprising the future time.

6. The computing system of claim 1, wherein the plurality of stores are grouped into a plurality of clusters by applying principal component analysis to the attributes of the plurality of stores, wherein applying principal component analysis comprises:
generating features from the attributes via linear combinations of the attributes;
selecting most beneficial features;
grouping the plurality of stores into the plurality of clusters based on the selected features.

7. The computing system of claim 1, wherein the plurality of demand bands comprises a low demand band, an average demand band, and a high demand band.

8. The computing system of claim 1, wherein the specified time period is longer than a base time period to which the plurality of data inputs corresponds.

9. The computing system of claim 1, wherein the plurality of resources further comprises parking spaces, floor space, or pick-up support staff

10. The computing system of claim 1, wherein fitting one or more polynomial equations onto the demand data further comprises selecting one of the one or more polynomial equations which has a highest r-squared value to be the demand growth curve for that cluster, wherein each of the one or more polynomial equations may be a first, second, third, fourth, or fifth-order polynomial equation.

11. The computing system of claim 1, wherein the low-temperature product demand comprises freezer product demand and refrigerated product demand; and wherein the low-temperature product capacity comprises freezer product capacity and refrigerated product capacity.

12. The computing system of claim 11, wherein the pick-up demand projection further comprises:
a freezer peak demand of the freezer product demand;
a freezer off-peak demand of the freezer product demand;
a refrigerated peak demand of the refrigerated product demand;
a refrigerated off-peak demand of the refrigerated product demand;
a dry peak demand of the dry product demand; and
a dry off-peak demand of the dry product demand.

13. The computing system of clam 1, wherein the computing system is communicatively connected to a second computer system, the second computer system comprising a planogram layout platform and configured to receive the resource allocation plan.

14. The computing system of claim 1, wherein the plurality of data inputs further comprises:
enterprise resource commitment guidance;
demographic data associated with each store of the plurality of stores;
same-day crowdsourced customer delivery service data; and
external market data.

15. A method for predicting an amount of resources required to accommodate a pick-up demand projection at a store of a retail enterprise, comprising:
receiving a plurality of data inputs, wherein the plurality of data inputs comprises:
historical pick-up sales data associated with a plurality of stores, the plurality of stores including the store;
resource capacity data associated with a resource for the plurality of stores; and
store attribute data of the plurality of stores;
grouping the store with one or more of the plurality of stores into one of a plurality of clusters, based on the store attribute data, the store attribute data comprising a plurality of attributes selected from among:
dry vs. low-temperature product data;
division breakout percentage;
pick-up acceleration rate;
pick-up saturation data;
census data of an area surrounding each of the plurality of stores, the census data including guest demographics;
store velocity grouping;
units per order; and
proximity of one or more competing stores;
determining a demand growth curve to fit demand data associated with each of the plurality of clusters by fitting one or more polynomial equations onto the demand data associated with each of the plurality of clusters;
calculating the rate of change for each of the plurality of clusters based on the demand growth curve associated with each of the plurality of clusters;
based on the rate of change, categorizing each of the plurality of clusters into one of a plurality of demand bands;
determining the pick-up demand projection for each store of each cluster of each of the plurality of demand bands over a specified time period, wherein the pick-up demand projection comprises:
low-temperature product demand; and
dry product demand;
predicting an amount of each of the plurality of resources necessary to accommodate the pick-up demand for each store of each cluster, wherein the plurality of resources comprises:
low-temperature product capacity; and
dry product capacity;
generating a resource allocation plan for each cluster, for at least one resource of the plurality of resources; and
assigning the resource allocation plan to the store, based on the resource allocation plan for the cluster into which the store is grouped.

16. The method of claim 15, further comprising:
generating an output report, the output report comprising the resource allocation plan; and
storing the output report in an enterprise reports database.

17. The method of claim 15, further comprising determining that the store is an outlier store, where a projected pick-up order sales of the store exceeds a specified percentage of historical total sales of the store, wherein the projected pick-up order sales is based on the pick-up demand projection.

18. The method of claim 15, further comprising:
determining, based at least on the pick-up demand projection and store attribute data associated with the store, the store attribute data comprising a store capacity, a future time at which the plurality of resources necessary to accommodate the pick-up demand for the store will exceed the store capacity; and
generating a user interface comprising the future time.

19. The computing system of claim 15, wherein the plurality of stores are grouped into a plurality of clusters by applying principal component analysis to the attributes of the plurality of stores, wherein applying principal component analysis comprises:
generating features from the attributes via linear combinations of the attributes;
selecting most beneficial features;
grouping the plurality of stores into the plurality of clusters based on the selected features.

20. The method of claim 15, wherein the specified time period is longer than a base time period to which the plurality of data inputs corresponds.

21. The method of claim 15, wherein fitting one or more polynomial equations onto the demand data further comprises selecting one of the one or more polynomial equations which has a highest r-squared value to be the demand growth curve for that cluster, wherein each of the one or more polynomial equations may be a first, second, third, fourth, or fifth-order polynomial equation.

22. The method of claim 15, wherein the plurality of data inputs further comprises:
enterprise resource commitment guidance;
demographic data associated with the plurality of stores;
same-day crowdsourced customer delivery service data associated with the plurality of stores; and
external market data, the external market data originating outside of the retail enterprise.

23. A system comprising:
a resource planning platform comprising a first computer system configured to:
receive a plurality of data inputs, wherein the plurality of data inputs comprise:
historical pick-up sales data associated with the plurality of stores;
resource capacity data associated with a resource for each store of the plurality of stores; and
store attribute data of each store of the plurality of stores;
group the plurality of stores into a plurality of clusters, based on the store attribute data, the store attribute data comprising a plurality of attributes selected from among:
dry vs. low-temperature product data;
division breakout percentage;
pick-up acceleration rate;
pick-up saturation data;
census data of an area surrounding each of the plurality of stores, the census data including guest demographics;
store velocity grouping;
units per order; and
proximity of one or more competing stores;
determine a demand growth curve to fit demand data associated with each of the plurality of clusters by fitting one or more polynomial equations onto the demand data associated with each of the plurality of clusters;
calculate the rate of change for each of the plurality of clusters based on the demand growth curve associated with each of the plurality of clusters;
based on the rate of change, categorize each of the plurality of clusters into one of a plurality of demand bands;
determine the pick-up demand projection for each store of each cluster of each of the plurality of demand bands over a specified time period, wherein the pick-up demand projection comprise:
freezer product demand;
refrigerated product demand; and
dry product demand;
predict an amount of each of the plurality of resources necessary to accommodate the pick-up demand for each store, wherein the plurality of resources comprises:
freezer product capacity;
refrigerated product capacity; and
dry product capacity; and
generate a resource allocation plan for each cluster, for at least one resource of the plurality of resources;
assign the resource allocation plan to each store of each cluster; and
a planogram layout platform, executing on a second computer system communicatively connected to the first computer system, configured to:
receive the resource allocation plan for at least one store of the plurality of stores;
receive planogram input data, the planogram input data comprising:
a current planogram for the at least one store; and
store attribute data associated with the at least one store, the store attribute data comprising store footprint capacities associated with the one or more resources;
generate a new planogram for the at least one store, based on the resource allocation plan and the store attribute data; and
generate a user interface comprising the new planogram.
